(19) United States
(12) Patent Application Publication
(10) Pub. No.: US 2009/0323913 A1
(43) Pub. Date: Dec. 31, 2009

(54) HOME APPLIANCE AND HOME APPLIANCE SYSTEM

(76) Inventors: Phal Jin LEE, Changwon-si (KR); Hoi Jin JEONG, Changwon-si (KR); Jong Hye HAN, Changwon-si (KR); Young Soo KIM, Changwon-si (KR); In Haeng CHO, Changwon-si (KR); Si Moon JEON, Changwon-si (KR)

Correspondence Address: KED & ASSOCIATES, LLP, P.O. Box 221200, Chantilly, VA, 20153-1200, US

(21) Appl. No.: 12/431,893

(22) Filed: Apr. 29, 2009

Related U.S. Application Data
(60) Provisional application No. 61/048,759, filed on Apr. 29, 2008.

(30) Foreign Application Priority Data
Apr. 29, 2008 (KR) 10-2008-0040023
Apr. 9, 2009 (KR) 10-2009-0030949

(51) Int. Cl. H04M 11/00; G08B 21/00

(52) U.S. Cl. 379/106.01; 340/679; 340/691.5

(57) ABSTRACT

A home appliance and a home appliance system are provided which control a sound output from an output device upon receipt of an external command signal of ON or OFF. Further, the home appliance and home appliance system control a sequence of output of an acoustic signal output from a conversion device. Accordingly, it may be possible to notify a user of the outputting of the acoustic signal by controlling the sequence of output of the acoustic signal, thereby increasing user convenience.

This application claims priority to U.S. Provisional Application No. 61/048,759 filed Apr. 29, 2008, Korea Application No. 10-2008-0040023 filed in Korea on Apr. 29, 2008, and Korea Application No. 10-2009-0030949 filed in Korea on Apr. 9, 2009, which are hereby incorporated by reference.

### BACKGROUND

1. Field

The present invention relates to a home appliance and a home appliance system, and more particularly, to a home appliance and a home appliance system which enable a user to conveniently transmit an output sound to a service center, when a sound including product information of the home appliance is output.

2. Background

Home appliances and home appliance systems are known. However, they suffer from various disadvantages.

### SUMMARY OF THE INVENTION

In accordance with an embodiment of the present invention, there is provided a home appliance, including a controller that includes a storage device for storing the product information of the home appliance for the fault diagnosis, and loads the product information stored in the storage device and outputs a control signal, when the fault diagnosis command is received; a conversion device that converts the control signal which includes product information into at least one acoustic signal and outputs the at least one acoustic signal; and a output device that outputs a sound corresponding to the at least one acoustic signal.

In accordance with an embodiment of the present invention, there is provided a home appliance system, including a conversion device that, upon receipt of a control command, converts product information into at least one acoustic signal and outputs the at least one acoustic signal if the external command signal is ON, and does not output the at least one acoustic signal if the external command signal is OFF; an output device that outputs a sound corresponding to the at least one acoustic signal output from the conversion device; a controller that controls the at least one acoustic signal converted and output by the conversion device, so that a user is notified that the product information is about to be output; and a management device configured to receive the sound and inversely convert the sound into the product information based on the sound.

### BRIEF DESCRIPTION OF THE DRAWINGS

Embodiments will be described in detail with reference to the following drawings in which like reference numerals refer to like elements, and wherein:

FIG. 1 is a front perspective view of a home appliance in the form of a laundry treatment machine according to an embodiment;

FIG. 2 is a block diagram of a control flow of the laundry treatment machine of FIG. 1;

FIG. 3 is a conceptual view showing separation of a plurality of acoustic signals S1, S2, S3 output from the conversion device of FIG. 2 according to an embodiment;

FIG. 4 is a conceptual view showing separation of a plurality of acoustic signals S1, S2, S3 output from the conversion device of FIG. 2 according to another embodiment;

FIG. 5 is a perspective view of a home appliance system in the form of a laundry treatment machine system W1 according to an embodiment;

FIG. 6 is a block diagram of a control flow of the laundry treatment machine system W1 of FIG. 5;

FIG. 7 is a flowchart showing an operating method of a home appliance according to an embodiment; and

FIGS. 8 to 12 are views illustrating an operating method of a home appliance according to the present invention via screens displayed on a display device of the home appliance.

### DETAILED DESCRIPTION

Conventionally, when problems with home appliances occur, users usually call a service center to ask for a repairman to come for repairs. However, the repairman's visit(s) incur excessive costs, and often it is not easy to deal with problems when doing the repairs because no prior information was provided. With technological development, a technique of remotely diagnosing fault information by using a telephone network has been developed.

European Patent No. 0510519 discloses a technique of sending fault information of a home appliance to a service center by using a telephone network via a modem connected to the home appliance. With this technique, the modem must be connected to the home appliance. However, a home appliance, such as a laundry treatment machine, may be installed outdoors, and thus, there are location restrictions that must be considered when connecting the laundry treatment machine and the telephone network.

Patent Registration No. U.S. Pat. No. 5,987,105 discloses a technology for converting fault information of a home appliance into an audible frequency sound via a telephone network, and transmitting the sound to a service center via a telephone. In order to transmit the sound to the service center, a user should put the telephone in front of a sound output unit that outputs a sound. The user is not informed of how much sound must be transmitted to the service center, and how long the sound will be output. Therefore, a sufficient amount of sound may not be transmitted to the service center, and the user may maintain the telephone in front of the sound output unit even after the end of the sound.

Embodiments disclosed herein relate to a home appliance and a home appliance system. Embodiments of a home appliance and home appliance system will be described with reference to a laundry treatment machine and a laundry treatment machine system as examples. However, embodiments are not limited to a laundry treatment machine and a laundry treatment machine system, but rather, may be employed as other home appliances and home appliance systems. Such home appliances may include, for example, a TV, an air conditioner, a washing machine, a refrigerator, an electric rice cooker, or a microwave or conventional oven.

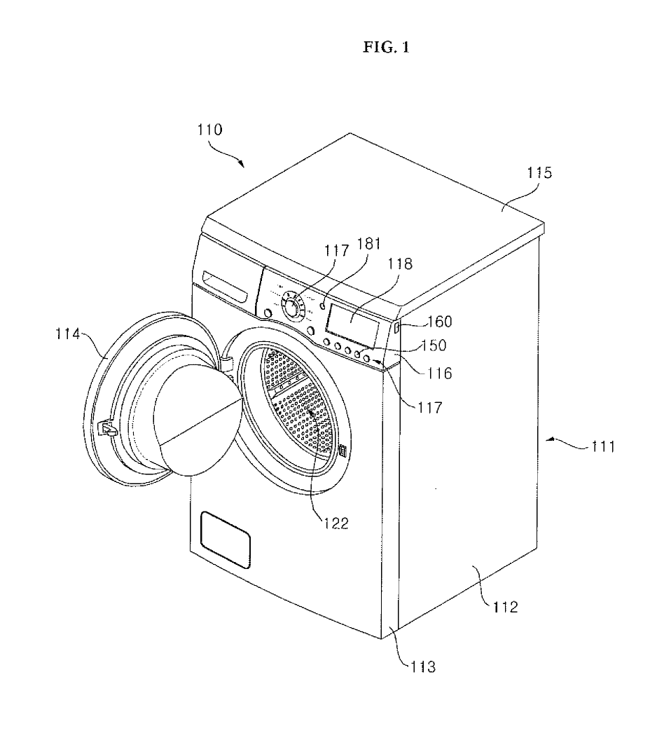

FIG. 1 is a front perspective view of a laundry treatment machine 110 according to an embodiment. As set forth above, embodiments are not limited to a laundry treatment machine, but rather, are applicable to any home appliance. However, for convenience of explanation, a laundry treatment machine will be described.

Referring to FIG. 1, the laundry treatment machine 110 may include a cabinet 111, a tub 122 disposed inside the cabinet 111 that performs washing of laundry, a motor (not shown) that drives the tub 122, a washing fluid supply device (not shown) that supplies washing fluid to the tub 122, and a drainage device (not shown) that discharges washing fluid outside of the laundry treatment machine 110 after washing is completed. The cabinet 111 may include a cabinet body 112, a cabinet cover 113 coupled to the cabinet body 112, a control panel 116 disposed on the cabinet cover 113 to control operation of the laundry treatment machine 110, and a top plate 115. The cabinet cover 113 may include a hole 114a (see FIG. 1) through which laundry may be put into/removed from the tub 122 and a door 114 rotatably attached to the cabinet cover 113 that rotates to open and close the hole 114a.

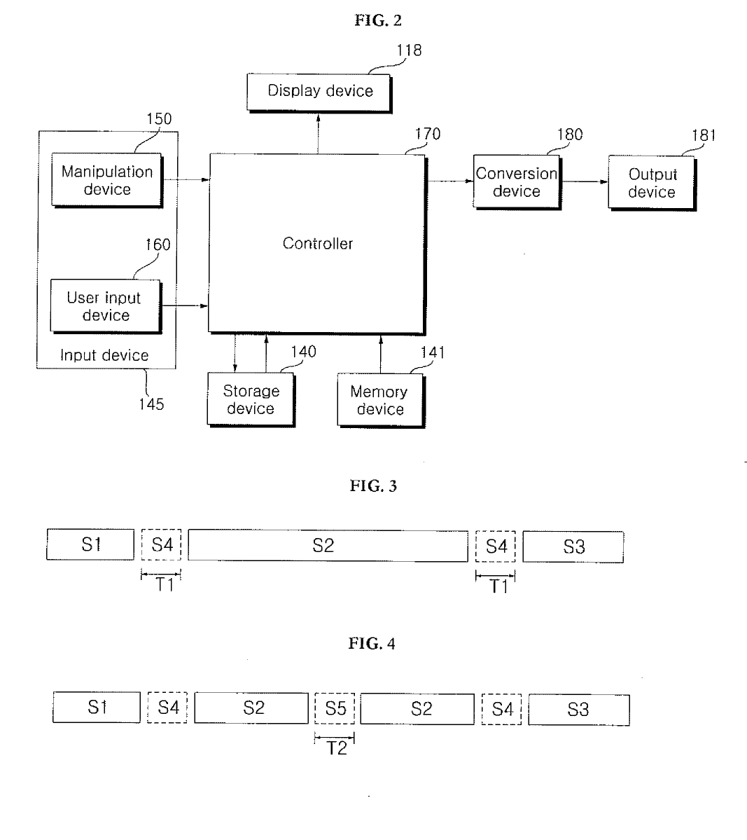

FIG. 2 is a block diagram of a control flow of the laundry treatment machine 110 of FIG. 1. Referring to FIG. 2, the laundry treatment machine 110 may an input device 145 configured to receive a control command from outside of the laundry treatment machine 110, a conversion device 180 that upon receipt of the control command converts a control signal which includes product information into at least one acoustic signal and outputs the same, a controller 170 that transmits a control signal which includes product information and controls the conversion device 180 to output the at least one acoustic signal, and an output device 181 that outputs a sound corresponding to the at least one acoustic signal output from the conversion device 180 so that a user may be notified or made aware of the outputting of the sound from the laundry treatment machine 110. The laundry treatment machine 110 may further include a storage device 140 that stores product information which will be transmitted to the management device 290, a memory device 141 configured to store a data transmitted from the input device 145 temporarily, and a display device 118 that displays image corresponding to signal from the controller 170. A storage device 140 can be included in the controller 170. EEPROM (Electrically Erasable Programmable Read-Only Memory) can be the storage device 140.

The input device 145 may include a manipulation device 150 and the control command may comprise an ON or OFF command. The user may input user's operation mode or option related to product operation through the manipulation device 150. Further, the conversion device 180 may convert product information into at least one acoustic signal and output the same if the ON command is input from the manipulation device 150 and may not output the at least one acoustic signal if the OFF command is input from the manipulation device 150.

When the laundry treatment machine 110 is operated, product information may be generated. A control signal which includes product information may be sent to the conversion device 180. The product information may be made up of signals. Further, the product information may include at least one of operating information or fault information of the laundry treatment machine 110. The operating information may include information required for the operation of the laundry treatment machine 110, such as information about a washing stroke, a dehydration stroke, and a rinsing stroke. The fault information may be variously selected from fault information generated during each operation of the laundry treatment machine 110, for example, mechanical fault information of the laundry treatment machine 110.

The controller 170 may transmit the control signal which includes the product information to the conversion device 180. The control signal may include not only product information but also various information to generate the acoustic signal and to control the conversion device, and the output device. The transmitted product information may be converted into at least one acoustic signal in the conversion device 180. When the ON command is input from the manipulation device 150, the conversion device 180 may convert the product information into the at least one acoustic signal and output it to the output device 181. The output device 181 may receive the at least one acoustic signal and output the same as a sound corresponding to the at least one acoustic signal.

The conversion device 180 may change stored data in the storage device 140 into acoustic signal which can be outputted to the output device 181. That is, the conversion device 180 may include an encoder and a modulator. The encoder may encode each bit of the product information into symbols. The modulator may modulate the symbols onto an analog signal. The modulated signal, e.g. the at least one acoustic signal, may then be output to the output device 181. The output device 181 may receive the modulated signal, e.g. the at least one acoustic signal, and output the same as a sound.

The modulator may modulate the symbols using, for example, any one of a frequency shift keying method, an amplitude shift keying method, or a phase shift keying method. The frequency shift keying method is a modulation method that modulates a data value of the product information onto a signal of a predetermined frequency. The amplitude shift keying method is a modulation method that varies a level of amplitude in response to a data value. The phase shift keying method is a modulation method that varies a phase according to a data value of the product information.

As discussed above, the user may control the conversion device 180 through the manipulation device 150. When the user inputs the ON command into the manipulation device 150, the controller 170 may transmit control signal which includes product information to the conversion device 180, the conversion device 180 may convert the transmitted product information into the at least one acoustic signal and output it. On the other hand, when the user inputs the OFF command into the manipulation device 150, the controller 170 may not output the control signal which includes product information. Therefore, the user is able to control the at least one acoustic signal generated by the conversion device 180 through the manipulation device 150 based on the outside environment. For example, in the case that external noise is generated by video equipment or other home appliances in the outside environment, the user may control the output of the at least one acoustic signal by inputting the OFF command into the manipulation device 150. Further, when the external noise is reduced, the user may output the acoustic signal from the conversion device 180 by inputting an external command signal of ON into the manipulation device 150. Thus, the user is able to control the conversion device 180 by inputting the ON command through the manipulation device 150 when the user wants. The output device 181 may be, for example, a speaker or a buzzer, and may include any means for outputting a sound from the laundry treatment machine 110.

Further, the input device 145 may further include a user input device 160. A user may input an operation command signal through the user input device 160. The user can also choose a menu to transmit product information to the management device 290. When the operation command signal is input through the user input device 160, the controller 170 may control the conversion device 180 to output the at least one acoustic signal and control the at least one acoustic signal converted and output by the conversion device 180, the output device 181 may receive the at least one acoustic signal, and output the same as a sound so that the user may be notified or made aware of the outputting of the sound. Embodiments of the at least one acoustic signal will be described below in detail.

Meanwhile, in a case where two buzzers exist on a laundry treatment machine 100, a first buzzer is a device that outputs a general sound, e.g., a washing end sound and a button effect sound from the laundry treatment machine 100, and a second buzzer is a device that outputs a sound including product information. When the second buzzer outputs the sound including the product information, the first buzzer can output a start sound notifying the output of the sound including the product information, and an end sound notifying the end of the output of the sound including the product information.

FIG. 3 is a conceptual view of separation of a plurality of acoustic signals S1, S2, and S3 output by the conversion device 180 of FIG. 2. Referring to FIG. 3, the at least one acoustic signal may include a plurality of acoustic signals S1, S2, and S3. The plurality of acoustic signals S1, S2, and S3 may include a first acoustic signal S1 output by the conversion device 180 to make the user aware that the product information is to be output, a second acoustic signal S2 including the product information converted and output by the conversion device 180 upon completion of the conversion and output of a sound corresponding to the first acoustic signal S1, and a third acoustic signal S3 converted and output by the conversion device 180 to make the user aware of completion of the conversion and output of a sound corresponding to the second acoustic signal S2.

That is, when the laundry treatment machine 110 is operated and the user inputs the ON command through the manipulation device 150, the controller 170 transmits the control signal which includes the product information to the conversion device 180. Once the product information is transmitted to the conversion device 180, the conversion device 180 converts the product information into a second acoustic signal S2. Upon completion of the conversion of the product information into the second acoustic signal S2, the conversion device 180 transmits the first acoustic signal S1 to the output device 181. A sound corresponding to the transmitted first acoustic signal S1 may be output from the laundry treatment machine 110 by the output device 181. That is, a sound corresponding to the first acoustic signal S1 may be output by the output device 181 to inform the user that a sound corresponding to the second acoustic signal S2 is to be output thereafter. When the outputting of the sound corresponding to the first acoustic signal S1 is completed, the conversion device 180 may transmit the second acoustic signal S2 to the output device 181. Upon transmission of the second acoustic signal S2, the control signal transmitted from the controller 170 to the conversion device 180 may be include in the acoustic signal and control the output device 181 to output a sound corresponding to the second acoustic signal S2. When the outputting of the sound corresponding to the second acoustic signal S2 is completed, the controller 170 may control the conversion device 180 to output a third acoustic signal to the output device 181. The sound corresponding to the third acoustic signal S3 informs the user that the outputting of the second acoustic signal S2 is completed.

The sound corresponding to the first acoustic signal S1 and the sound corresponding to the third acoustic sound S3 may include, for example, at least one of a voice recognizable by the user, a melody, and a buzzer sound. When the sound corresponding to the first acoustic signal S1 is output from the output device 181, the user may get ready for the transmission of the second acoustic signal S2 corresponding to the product information. Further, when the sound corresponding to the third acoustic signal S3 is output from the output device 181, the user may be made aware that the transmission of the second acoustic signal S2 corresponding to the product information is completed. Therefore, the user may be correctly informed of the transmission of the product information, thereby increasing user convenience. Further, upon outputting of the second acoustic signal S2, it may be possible to eliminate factors disturbing the sound corresponding the second acoustic signal S2 and the user may prepare for the outputting of the second acoustic signal S2, thereby efficiently outputting the product information.

Meanwhile, the conversion device 180 may output a separation signal S4 to separate the acoustic signals S1, S2, and S3 during a dummy time T1 between the first acoustic signal S1, the second acoustic signal S2, and the third acoustic signal S3. That is, when the outputting of the first acoustic signal S1 from the conversion device 180 is completed, a separation signal S4 may be output during a dummy time T1. Further, when the outputting of the separation signal S4 is completed, the conversion device 180 may output the second acoustic signal S2. When the outputting of the second acoustic signal S2 is completed, the conversion device 180 may output a separation signal S4 during a dummy time T1. Finally, when the outputting of the separation signal S4 is completed, the conversion device 180 may output the third acoustic signal S3. Therefore, the user may get ready to correctly output the second acoustic signal S2 corresponding to the product information during the dummy time T1. As the second acoustic signal S2 is correctly output, this may prevent damage to the product information. Further, when the separation signal S4 is input into the output device 181, the control signal from the controller 170 may be included in the acoustic signal and control the output device 181 to output a sound corresponding to the separation signal S4 as mute.

FIG. 4 is a conceptual view of separation of a plurality of acoustic signals S1, S2, and S3 according to another embodiment. Like reference numerals have been used to refer to like elements. Referring to FIG. 4, when the external command signal is input from the user input device 160, the controller 170 may control the conversion device 180 to output a first acoustic signal S1 and can control the first acoustic signal S1. When the outputting of the first acoustic signal S1 is completed, the conversion device 180 may convert the product information into a second acoustic signal S2 and output it. The second acoustic signal S2 may be repetitively output. That is, when the outputting of the first acoustic signal S1 is completed, the conversion device 180 may output a second acoustic signal S2. Further, when the outputting of the second acoustic signal S2 is completed, the conversion device 180 may re-output the second acoustic signal S2. Therefore, if the second acoustic signal S2 output is damaged by external disturbing factors, correct information may be output by re-transmitting the second acoustic signal S2.

Meanwhile, a data separation signal S5 that separates the second acoustic signals S2 in between the repetitively output second acoustic signals S2 may be output from the conversion device 180 during a data dummy time T2. That is, the conversion device 180 may output a second acoustic signal S2, and upon completion of the outputting of the second acoustic signal S2, output a data separation signal S5 during a data dummy time T2. When the outputting of the data separation signal S5 is completed, the conversion device 180 may re-output the second acoustic signal S2. Therefore, the second acoustic signals S2 may be easily separated upon outputting of the second acoustic signals S2 by outputting the data separation signal S5 during the data dummy time T2. Further, the data separation signal S5 is input into the output device 181, the controller 170 may control the output device 181 to output a sound corresponding to the data separation signal S5 as mute.

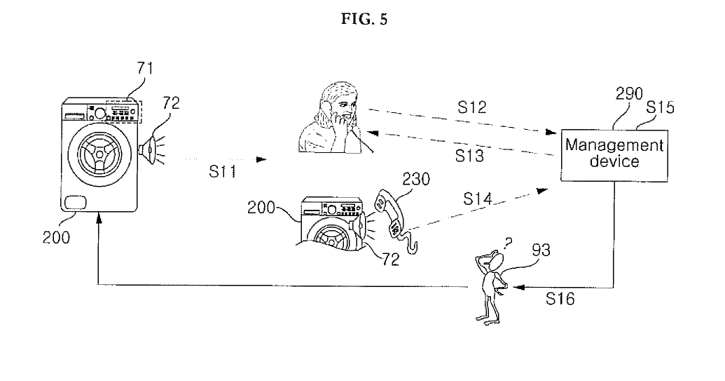

FIG. 5 is a perspective view of a home appliance system in the form of a laundry treatment machine system W1 according to an embodiment.

Referring to FIG. 5, a laundry treatment machine 200 includes output devices 71 and 72 that output predetermined product information; such that an operating state and fixed information of the laundry treatment machine 200 are output (S11). Here, the laundry treatment machine 200 includes a predetermined display device 71 and a output device 72 that outputs a sound.

At this time, the user confirms the product information of the laundry treatment machine 200 displayed on the output device of the laundry treatment machine 200, and controls the operation of the laundry treatment machine 200 or asks for repairs to a management device 290 (S12).

In a case where the user is connected to the management device 290 and manipulates an input device provided on the laundry treatment machine 200 upon the request of the management device 290 (S13), a sound including product information is output (S14), so that the management device 290 can check a product state of the laundry treatment machine 200 via the sound. Here, the laundry treatment machine 200 of the present invention does not simply output the product information but converts the product information into a predetermined sound and outputs the sound.

Hereinafter, a laundry treatment machine will be exemplified as the laundry treatment machine 200 of the present invention, which is not intended to be limiting. It is apparent that the present invention is applicable to a TV, air conditioner, washing machine, refrigerator, electric rice cooker and microwave oven as well as the laundry treatment machine 200.

When the user is connected to the management device through a predetermined communication network, e.g. a telephone network, the management device 290 confirms the sound output from the laundry treatment machine 200, judges the product state of the laundry treatment machine 200 (S15), and sends a repairman to the user so as to provide an appropriate service (S16).

Here, since the management device 290 can accurately judge and handle the state of the laundry treatment machine 200 via the sound, it can rapidly provide a service.

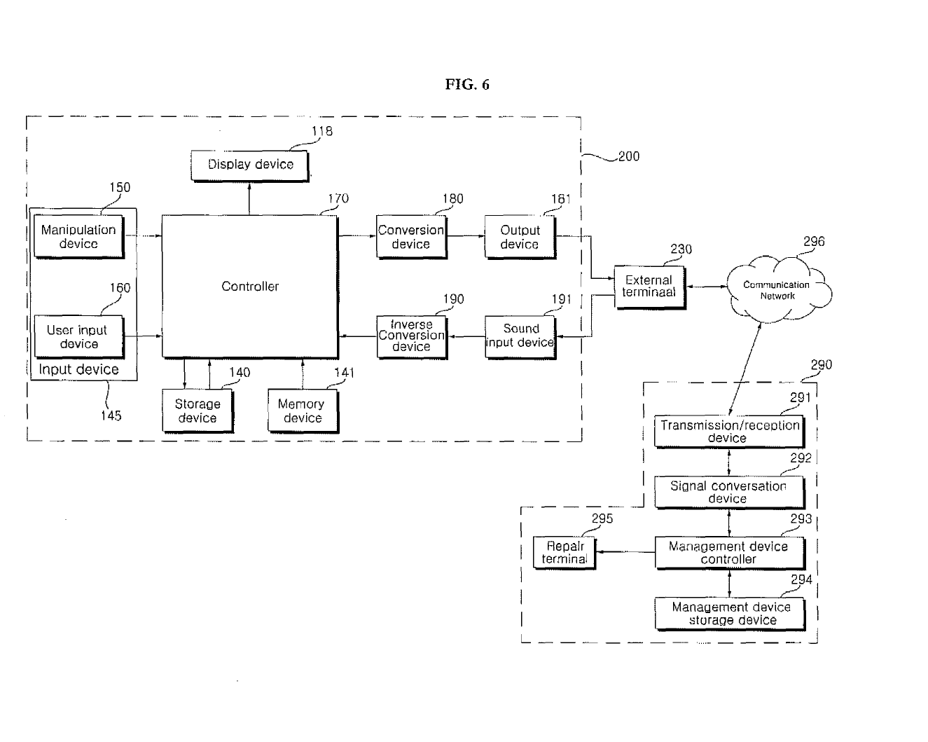

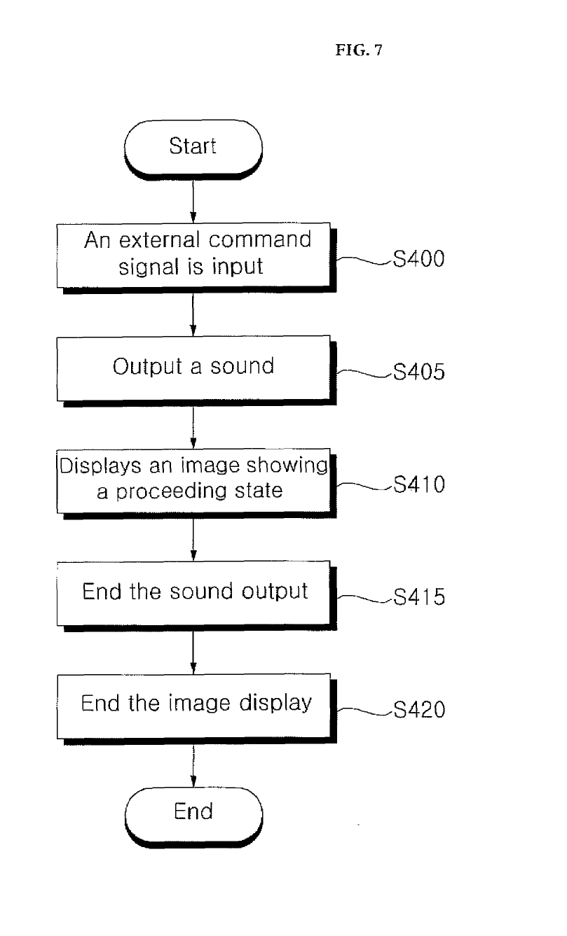

FIG. 6 is a block diagram of a control flow of the laundry treatment machine system W1 of FIG. 5.

Referring to FIG. 6, the laundry treatment machine system W1 may include the laundry treatment machine 200, the manipulation device 150 and the user input device 160 configured to receive a control command from outside of the system, the conversion device 180 that converts product information into at least one acoustic signal, the output device 181 that outputs a sound corresponding to the at least one acoustic signal output by the conversion device 180, a controller 170 that transmits a control signal which includes product information and controls the conversion device 180 to output the at least one acoustic signal so as to make a user aware of the outputting of the sound, and a management device 290 configured to receive the sound and inversely convert the sound into the product information based on the sound. The storage device 140 including product information can be included in the controller 170. The conversion device 180, the input device 160, the output device 181, and the controller 170 may be formed separately from the laundry treatment machine 200, or may be included in the laundry treatment machine 200.

The laundry treatment machine 200 may include the same or similar components as the laundry treatment machine of FIGS. 1 and 2. The management device 290 may include a transmission/reception device 291 that transmits and receives the sound output by the output device 181 of the laundry treatment machine 200, a signal conversion device 292 that inversely converts the sound received from the transmission/reception device 291 into the product information, a management device controller 293 that reads the converted product information, a management device storage device 294 that stores the product information read by the management device controller 293, and a repair terminal 295 that transmits the product information read by the management device controller 293 to a repairman.

A method for converting the product information of the laundry treatment machine 200 into an acoustic signal and outputting a sound corresponding to the acoustic signal, and a control flow thereof are the same or similar to those as described with respect to FIG. 2. Further, a method for converting the product information into an acoustic signal is also the same or similar to those as described in FIGS. 3 and 4.

The sound output from the output device 181 may be transmitted to the management device 290 via a communications network 296. Further, the laundry treatment machine system W1 may further include an external terminal 230 connected to the management device 290 and the communications network 296. The external terminal 230 may include any device capable of transmitting the sound output from the output device 181, such as a wired phone, a wireless phone, or a mobile phone, to the management device 290. The user may input the sound output from the output device 181 into the external terminal 230. In contrast to the description of FIG. 2, the sound input into the external terminal 230 may be converted into a voice signal, and the voice signal may be inversely converted into the product information. The inversely-converted product information may be compared with previously input data and linked to a repairman.

That is, regarding the control flow of the management device 290, as described in FIGS. 3 and 4, when the conversion device 180 outputs the acoustic signals, the output device 181 may output a sound corresponding to the acoustic signals. The output sound may be transmitted to the management device 290 through the external terminal 230 by the user. The transmitted sound may be received by the transmission/reception device 291. Further, the transmission/reception device 291 may be capable of outputting the sound generated by the management device 290 to outside of the management device 290, as well as receiving the sound. The received sound may be transmitted to the signal conversion device 292. In the transmission procedure, the sound may be converted into an acoustic signal and transmitted. The transmitted acoustic signal may be converted into the product information in the signal conversion device 292. The procedure of converting the transmitted acoustic signal may be done in a reverse manner to that described with respect to FIGS. 2 to 4. The converted product information may be transmitted to the management device controller 293. The management device controller 293 may store preset data therein. Therefore, the management device controller 293 may compare the preset data and the converted product information. If it is judged that the converted product information is different from the preset data, the management device controller 293 may transmit the converted product information to the repairman through the repair terminal 295. Further, the management device controller 293 may store the converted product information in the management device storage device 294. Therefore, a fault history or operation information of the laundry treatment machine 200 used by the user may be saved.

Meanwhile, the management device controller 294 may judge whether the converted product information is correctly transmitted, as well as compare the converted product information with the preset data. The converted product information may be damaged by external factors as it is transmitted to the management device controller 294. If the management device controller 294 judges that the converted product information is damaged, the management device controller 294 may transmit a re-transmit command indicating the damage of the converted product information to the signal conversion device 293. The transmitted re-transmit command may be converted into a management device acoustic signal in the signal conversion device 293. The converted management device acoustic signal may be transmitted to the transmission/reception device 291. The transmitted management device acoustic signal may be transmitted as a sound corresponding to the management device acoustic signal to the laundry treatment machine 291 through the external terminal 230. The transmitted sound may be transmitted to an sound input device 191, such as a microphone, and the re-transmit command may be converted through an inverse conversion device 190 and transmitted to the controller 170. Upon receipt of the re-transmit command, the controller 170 may re-transmit the product information to the conversion device 180. The re-transmitted product information may be output again through the output device 181 in a reverse manner as that described in FIGS. 2 to 4. Therefore, even when damaged product information is transmitted to the management device 290, the laundry treatment machine system W1 may receive the external command signal and repetitively transmit correct product information. Further, the laundry treatment machine system W1 may ensure correct repair of the laundry treatment machine 200 by correctly sending the product information.

Meanwhile, the management device controller 293 may discriminate the order of the first acoustic signal S1, the second acoustic signal S2, and the third acoustic signal S3. Further, the management device controller 293 may judge whether the second acoustic signal S2 is damaged. If it is judged that the sequence of the first acoustic signal S1, the second acoustic signal S2, and the third acoustic signal S3 is different from the previous input sequence, the management device controller 293 may output a re-transmit command through the transmission/reception device 291. When the re-transmit command is output, it may be transmitted to the inverse conversion device 190 through the sound input device 191. The re-transmit command transmitted to the inverse conversion device 190 may be converted into external information and transmitted to the controller 170. When the external information is transmitted to the controller 170, the controller 170 may control the conversion device 180 to re-output the plurality of acoustic signals S1, S2, and S3 based on the external information. Even if the plurality of acoustic signals S1, S2, and S3 generated in the laundry treatment machine 200 is damaged and transmitted to the management device 290, the user may re-transmit them by the re-transmit command. Thus, correct product information may be transmitted.

Meanwhile, the management device controller 293 may judge whether the second acoustic signal S2 is damaged. If it is judged that the second acoustic signal S2 is damaged, the management device controller 293 may output the re-transmit command in the same or similar manner as that described above. The re-transmit command may be input through the sound input device 191, and transmitted to the controller 170. Even if the second acoustic signal S2 is damaged, the management device 290 may receive the second acoustic signal S2 by re-outputting. Therefore, the product information may be correctly transmitted to the management device 290 and management of the laundry treatment machine 200 may be easier. Moreover, even if the user does not judge whether the second acoustic signal S2 is damaged, the second acoustic signal S2 may be retransmitted through the re-transmit command, thereby increasing user convenience.

FIG. 7 is a flowchart showing an operating method of a home appliance according to an embodiment of the present invention.

As illustrated in FIG. 7, first of all, an external command signal is input to a controller 170 via a manipulation device 150 (S400). The controller 170 outputs a sound including product information through an output device 181 according to the external command signal input to the manipulation device 150 (S405). While outputting the sound at step S405, the controller 170 displays an image showing a proceeding state on a display device 118 till an end point of the sound output (S410).

When the sound output reaches the end point, the controller 170 ends the sound output (S415), and also ends the image display (S420).

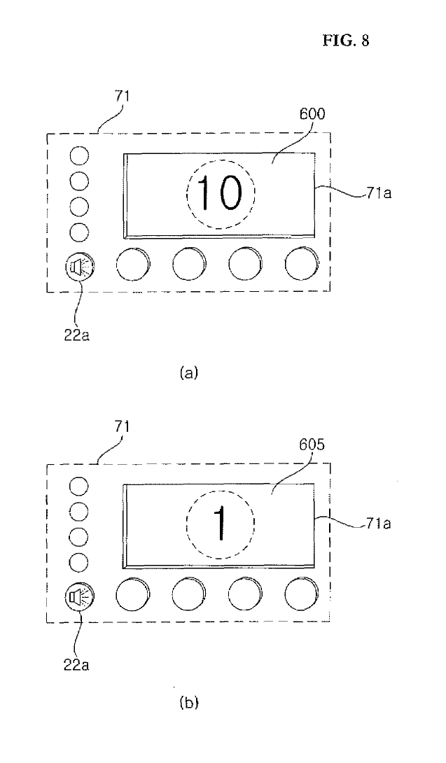

FIGS. 8 to 12 are views illustrating an operating method of a home appliance according to the present invention via screens displayed on a display device of the home appliance. Hereinafter, described are embodiments displaying an image showing a remaining time till an end point of sound output.

When a signal output command is input through a manipulation device 150, a sound including product information is output. As illustrated in FIG. 8(a), when a remaining time till an end point of the sound is 10 seconds, a numerical image 600 showing ‘10’ is displayed on a display device 71a. After 9 seconds elapse, as illustrated in FIG. 8(b), a numerical image 605 showing ‘1’ is displayed. That is, an inversely-counted number image is displayed on the display device 71a.

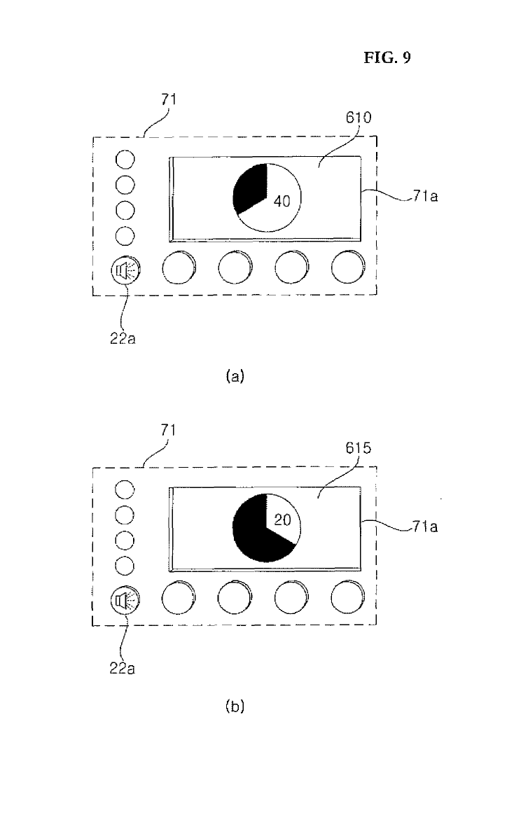

Meanwhile, as illustrated in FIG. 9(a), a numerical image 610 showing a remaining time ‘40 seconds’ is displayed on the display device 71a with a circle graph. After the time elapses, as illustrated in FIG. 9(b), a numerical image 615 showing a remaining time ‘20 seconds’ is displayed with the circle graph.

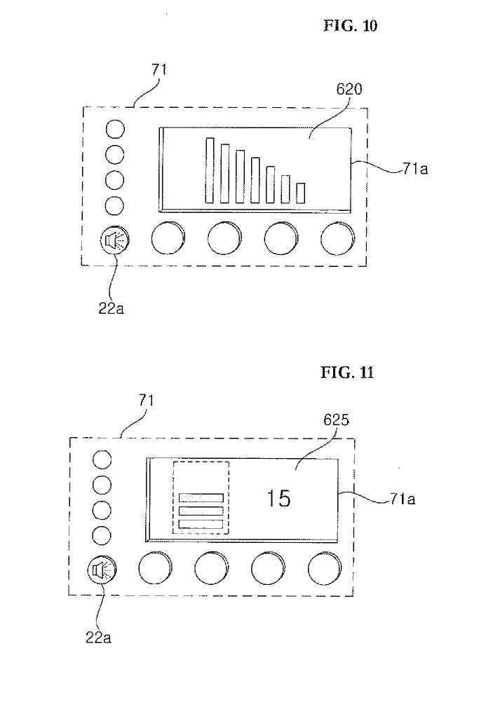

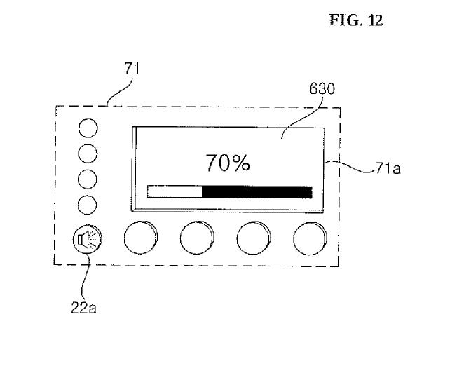

For yet another embodiment, as illustrated in FIG. 10, an image 620 showing various sizes of bar graphs is displayed. As the time elapses, display of the largest bar graph is ended first, to notify that a remaining time decreases. Referring to FIG. 11, an image 625 showing a plurality of bar graphs is displayed. As the time elapses, the number of the displayed bar graphs is reduced, to notify that a remaining time decreases. As illustrated in FIG. 12, a number 630 showing a percentage of a remaining time till a sound end point in an entire sound output time can be displayed with a graph.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. In a home appliance system that transmits product information of a home appliance to a management device through a wire/wireless communication network for fault diagnosis, and diagnoses fault of the home appliance,
the home appliance, including:
a controller that includes a storage device for storing the product information of the home appliance for the fault diagnosis, and loads the product information stored in the storage device and outputs a control signal, when the fault diagnosis command is received
a conversion device that converts the control signal which includes product information into at least one acoustic signal and outputs the at least one acoustic signal; and
a output device that outputs a sound corresponding to the at least one acoustic signal.

2. The home appliance of claim 1, further comprising:
an input device configured to receive the control command from outside of the home appliance.

3. The home appliance of claim 2, wherein the input device comprises a manipulation device and the control command comprises an ON or OFF command, wherein the conversion device, upon receipt of the ON or OFF command, converts product information into at least one acoustic signal and outputs the at least one acoustic signal if the ON command is input, and does not output the at least one acoustic signal if the OFF command is input.

4. The home appliance of claim 1, further comprising:
a storage device that stores the product information, wherein the controller transmits the control signal including the product information stored in the storage device to the conversion device if the user inputs the ON command into the manipulation device, and the conversion device converts the product information into the at least one acoustic signal.

5. The home appliance of claim 1, wherein the at least one acoustic signal comprises a plurality of acoustic signals, wherein the plurality of acoustic signals comprises:
a first acoustic signal configured to notify the user that the product information is about to be output; and
a second acoustic signal corresponding to the product information and configured to be output upon completion of the output of first acoustic signal.

6. The home appliance of claim 5, wherein the plurality of acoustic signals further comprises:
a third acoustic signal configured to notify the user that the product information has been output by the output device, wherein, when the conversion and outputting of the second acoustic signal is completed, the controller controls the conversion device to output the third acoustic signal.

7. The home appliance of claim 6, wherein a sound corresponding to the first acoustic signal and a sound corresponding to the third acoustic signal include at least one of a voice recognizable by the user, a melody, or a buzzer sound.

8. The home appliance of claim 6, wherein the controller controls the conversion device to output a separation signal to separate the plurality of acoustic signals during a dummy time between the first acoustic signal, the second acoustic signal, and the third acoustic signal.

9. The home appliance of claim 8, wherein, when the separation signal is input into the output device, the controller controls the output device to output a sound corresponding to the separation signal.

10. The home appliance of claim 5, wherein, when the outputting of the first acoustic signal is completed, the controller controls the output device to output the second acoustic signal a plurality of times.

11. The home appliance of claim 10, wherein the controller controls the conversion device to output a data separation signal during a data dummy time in between the plurality of second acoustic signals.

12. The home appliance of claim 11, wherein, when the data separation signal is input into the output device, the controller controls the output device to output a sound corresponding to the separation signal as mute.

13. The home appliance of claim 1, wherein the product information includes at least one of operating information and fault information of the home appliance.

14. The home appliance of claim 2, wherein the user device comprises an user input device configured to receive an operation control command from the user, wherein the controller controls a sequence of outputting the at least one acoustic signal when the user inputs the operation control command through the user input device.

15. The home appliance of claim 1, further comprising:
a display device that displays a first image showing a proceeding state till an end point of the sound output, while the sound is output through the output device.

16. The home appliance of claim 15, wherein the first image comprises at least one of a number, picture and graph.

17. The home appliance of claim 15, wherein the first image is an image where the number is inversely counted.

18. The home appliance of claim 15, wherein the first image is an image where the number of the graphs is reduced.

19. The home appliance of claim 15, wherein the first image is an image showing a percentage of a remaining time in an entire sound output time.

20. The home appliance of claim 15, wherein the first image comprises at least one of a bar graph, circle graph and line graph.

21. The home appliance of claim 15, wherein the proceeding state is any one of a remaining time till an end point of the sound output and an elapsed time till the end point of the sound output.

22. In a home appliance system that transmits product information of a home appliance to a management device through a wire/wireless communication network for fault diagnosis, and diagnoses fault of the home appliance,
the home appliance system, including:
a conversion device that, upon receipt of a control command, converts product information into at least one acoustic signal and outputs the at least one acoustic signal if the external command signal is ON, and does not output the at least one acoustic signal if the external command signal is OFF;
an output device that outputs a sound corresponding to the at least one acoustic signal output from the conversion device;
a controller that controls the at least one acoustic signal converted and output by the conversion device, so that a user is notified that the product information is about to be output; and
a management device configured to receive the sound and inversely convert the sound into the product information based on the sound.

23. The home appliance system of claim 22, further comprising an input device configured to receive the control command from the home appliance or from outside of the home appliance system.

24. The home appliance system of claim 23, wherein the input device comprises a manipulation device and the control command comprises an ON or OFF command, wherein the conversion device, upon receipt of the ON or OFF command, converts product information into at least one acoustic signal and outputs the at least one acoustic signal if the ON command is input, and does not output the at least one acoustic signal if the OFF command is input.

25. The home appliance system of claim 22, further comprising a storage device that stores the product information, wherein the controller transmits the product information stored in the storage device to the conversion device if the user inputs an ON command signal through the manipulation device, and the conversion device converts the product information into the at least one acoustic signal.

26. The home appliance system of claim 22, wherein the at least one acoustic signal comprises a plurality of acoustic signals, wherein the plurality of acoustic signals comprises:
a first acoustic signal configured to notify the user the product information is about to be output; and
a second acoustic signal corresponding to the product information output upon completion of the first acoustic signal.

27. The home appliance system of claim 26, wherein the plurality of acoustic signals further comprises:
a third acoustic signal configured to notify the user that the product information has been output by the output device, wherein, when the conversion and outputting of the second acoustic signal is completed, the controller controls the conversion device to output the third acoustic signal.

28. The home appliance system of claim 27, wherein a sound corresponding to the first acoustic signal and a sound corresponding to the third acoustic signal include at least one of a voice recognizable by the user, a melody, or a buzzer sound.

29. The home appliance system of claim 27, wherein the controller controls the conversion device to output a separation signal to separate the plurality of acoustic signals during a dummy time between the first acoustic signal, the second acoustic signal, and the third acoustic signal.

30. The home appliance system of claim 29, wherein, when the separation signal is input into the output device, the controller controls the output device to output a sound corresponding to the separation signal as mute.

31. The home appliance system of claim 26, wherein, when the outputting of the first acoustic signal is completed, the controller controls the output device to output the second acoustic signal a plurality of times.

32. The home appliance system of claim 31, wherein the controller controls the conversion device to output a data separation signal during a data dummy time between the plurality of second acoustic signals.

33. The home appliance system of claim 32, wherein, when the data separation signal is input into the output device, the controller controls the output device to output a sound corresponding to the separation signal as mute.

34. The home appliance system of claim 22, wherein the product information includes at least one of operating information or fault information of the home appliance.

35. The home appliance system of claim 23, wherein the user device comprises an user input device configured to receive an operation control command from a user, wherein the controller controls a sequence of outputting the at least one acoustic signal when the user inputs the operation control command through the user input device.

36. The home appliance system of claim 22, wherein the sound output from the output device is transmitted to the management device via a communications network.

37. The home appliance system of claim 36, further comprising an external terminal connected to the management device and the communications network, wherein the user inputs the sound output from the output device into the external terminal.

38. The home appliance system of claim 37, wherein the management device checks the product information by comparing the sound input from the external terminal with previously input data, judges a status of the home appliance based on the product information, and links the product information to a repairman.

39. The home appliance system of claim 22, wherein the management device comprises:
a transmission/reception device that transmits and receives sounds;
a signal conversion device that inversely converts the sounds received from the transmission/reception device into product information; and
a management device controller that reads the converted product information.

40. The home appliance system of claim 39, wherein the management device controller discriminates an order of the first acoustic signal, the second acoustic signal, and the third acoustic signal, and judges whether the second acoustic signal is damaged.

41. The home appliance system of claim 40, further comprising:
an sound input device configured to receive a re-transmit command; and
an inverse conversion device that converts the re-transmit command input into the sound input device and outputs the converted re-transmit command, wherein the management device controller discriminates an order of the first acoustic signal, the second acoustic signal, and the third acoustic signal, and if it is judged that a sequence of the first acoustic signal, the second acoustic signal, and the third acoustic signal is different from a previous input sequence, outputs the re-transmit command through the transmission/reception device, and when the re-transmit command is input into the input device, the controller controls the output device to re-output the acoustic signals.

42. The home appliance system of claim 40, further comprising:
an acoustic device configured to receive a re-transmit command; and
an inverse conversion device that converts the re-transmit command input into the sound input device and outputs the converted re-transmit command, wherein, if it is judged that the second acoustic signal is damaged, the management device controller outputs the re-transmit command through the transmission/reception device, and when the re-transmit command is input into the input device, the controller controls the output device to re-output the second acoustic signal.

43. The home appliance system of claim 22, further comprising:
a display device that displays a first image showing a proceeding state till an end point of the sound output, while the sound is output through the output device.

44. The home appliance system of claim 43, wherein the first image comprises at least one of a number, picture and graph.

45. The home appliance system of claim 43, wherein the first image is an image where the number is inversely counted

46. The home appliance system of claim 43, wherein the first image is an image where the number of the graphs is reduced.

47. The home appliance system of claim 43, wherein the first image is an image showing a percentage of a remaining time in an entire sound output time.

48. The home appliance system of claim 43, wherein the first image comprises at least one of a bar graph, circle graph and line graph.

49. The home appliance system of claim 43, wherein the proceeding state is any one of a remaining time till an end point of the sound output and an elapsed time till the end point of the sound output.
